(19) United States
(12) Patent Application Publication
(10) Pub. No.: US 2025/0174943 A1
(43) Pub. Date: May 29, 2025

(54) CONNECTION COMPONENT AND CONNECTION COMPONENT SET

(71) Applicant: Yazaki Corporation, Tokyo (JP)

(72) Inventor: Takahiko KATSURAMAKI, Makinohara-shi (JP)

(73) Assignee: Yazaki Corporation, Tokyo (JP)

(21) Appl. No.: 18/928,490

(22) Filed: Oct. 28, 2024

(30) Foreign Application Priority Data
Nov. 29, 2023 (JP) 2023-201827

(51) Int. Cl. H01R 13/6592

(52) U.S. Cl. CPC H01R 13/6592

(57) ABSTRACT

A connection component in the present disclosure includes a first member, a second member, and a pressing portion. The first member faces a first shield member including a first portion that covers an outer circumference of an electric wire and a second portion that covers an outer periphery of an end portion of a shield layer of a bus bar from a second direction that intersects a first direction. The second member is disposed on an opposite side of the first member with respect to the first shield member and is assembled with the first member. When the first member and the second member are assembled with each other, the pressing portion presses the second portion of the first shield member toward the end portion of the shield layer.

### BACKGROUND OF THE INVENTION

### Field of the Invention

Embodiments of the present invention relate to a connection component and a connection component set.

Priority is claimed on Japanese Patent Application No. 2023-201827, filed Nov. 29, 2023, the content of which is incorporated herein by reference.

### Description of Related Art

A conduction passage including a bus bar, an insulation portion that surrounds an outer periphery of the bus bar, and a shield member that surrounds the bus bar and the insulation portion is known.

### Prior Art Document

### Patent Document

[Patent document 1] Japanese Unexamined Patent Application, First Publication No. 2011-146237

### SUMMARY OF THE INVENTION

In a case of assuming a constitution in which a bus bar including a shield layer is connected with an electric wire provided with a shield member, by the way, work of electrically connecting the above shield layer and the above shield member may be complicated.

According to one embodiment of the present disclosure, a connection component and a connection component set that are capable of improving work performance.

A connection component in one embodiment is used for a routing unit including a first routing member and a second routing member. The first routing member is a first bus bar including a conductor, an insulation film that covers an outer periphery of the conductor, and a shield layer that covers an outer periphery of the insulation film. The conductor includes a conductor end portion that protrudes from the shield layer. The second routing member is a first electric wire including a core wire and an insulation film that covers an outer circumference of the core wire. The core wire includes a core wire end portion that protrudes from the insulation film of the first electric wire. The connection component includes a first member, a second member, and a pressing portion. In a case where a first direction is defined as a direction in which the core wire end portion protrudes from the insulation film of the first electric wire, the first member faces the first shield member from a second direction that intersects the first direction, in a state in which the conductor end portion and the core wire end portion are joined together and a first shield member is provided. The first shield member includes a first portion that covers an outer circumference of the first electric wire, and a second portion that covers an outer periphery of an end portion of the shield layer. The second member is disposed on an opposite side of the first member with respect to the first shield member and is assembled with the first member. The pressing portion is provided on at least one of the first member or the second member, and presses the second portion of the first shield member toward the end portion of the shield layer, when the first member and the second member are assembled with each other.

A connection component set in one embodiment is a connection component set used for a routing unit including a first routing member and a second routing member. The first routing member is a bus bar including a conductor, an insulation film that covers an outer periphery of the conductor, and a shield layer that covers an outer periphery of the insulation film. The conductor includes a conductor end portion that protrudes from the shield layer. The second routing member is an electric wire including a core wire and an insulation film that covers an outer circumference of the core wire. The core wire includes a core wire end portion that protrudes from the insulation film of the electric wire. The connection component set includes a shield member and a connection component. The shield member includes a first portion that covers an outer circumference of the insulation film of the electric wire, and a second portion that covers an outer periphery of an end portion of the shield layer. The connection component includes a first member, a second member, and a pressing portion. In a case where a first direction is defined as a direction in which the core wire end portion protrudes from the insulation film of the electric wire, the first member faces the shield member from a second direction that intersects the first direction, in a state in which the conductor end portion and the core wire end portion are joined together and the shield member that covers an outer circumference of the insulation film of the electric wire and an outer periphery of the end portion of the shield layer is provided. The second member is disposed on an opposite side of the first member with respect to the shield member and is assembled with the first member. The pressing portion is provided on at least one of the first member or the second member, and presses the second portion of the shield member toward the end portion of the shield layer, when the first member and the second member are assembled with each other.

According to one embodiment, it becomes possible to provide a connection component and a connection component set that are capable of improving work performance.

### BRIEF DESCRIPTION OF THE DRAWINGS

FIG. 1 is a perspective view illustrating a routing unit in an embodiment;

FIG. 2 is an exploded perspective view illustrating part of the routing unit in an embodiment;

FIG. 3 is a perspective view illustrating an end portion of a shield bus bar in an embodiment;

FIG. 4 is a cross-sectional view taken along line F4-F4 of the shield bus bar illustrated in FIG. 3;

FIG. 5 is a cross-sectional view taken along line F5-F5 of the routing unit illustrated in FIG. 1;

FIG. 6 is a cross-sectional view taken along line F6-F6 of the routing unit illustrated in FIG. 5;

FIG. 7 is a diagram for describing an assembling method of the routing unit in an embodiment; and

FIG. 8 is a diagram illustrating a routing unit in a modification of an embodiment.

### DETAILED DESCRIPTION OF THE INVENTION

Hereinafter, embodiments of the present invention will be described with reference to the drawings. In the following description, constitutions having the same or similar functions are denoted by the same reference numbers. In addition, overlapping descriptions of these constitutions will be omitted, in some cases. In the present disclosure, the terms are defined as follows. The term “connection” is not limited to a mechanical connection and can include an electric connection. That is, the term “connection” is not limited to a case where two elements to be connected are directly connected and may include a case where two elements to be connected are connected with another element interposed between them.

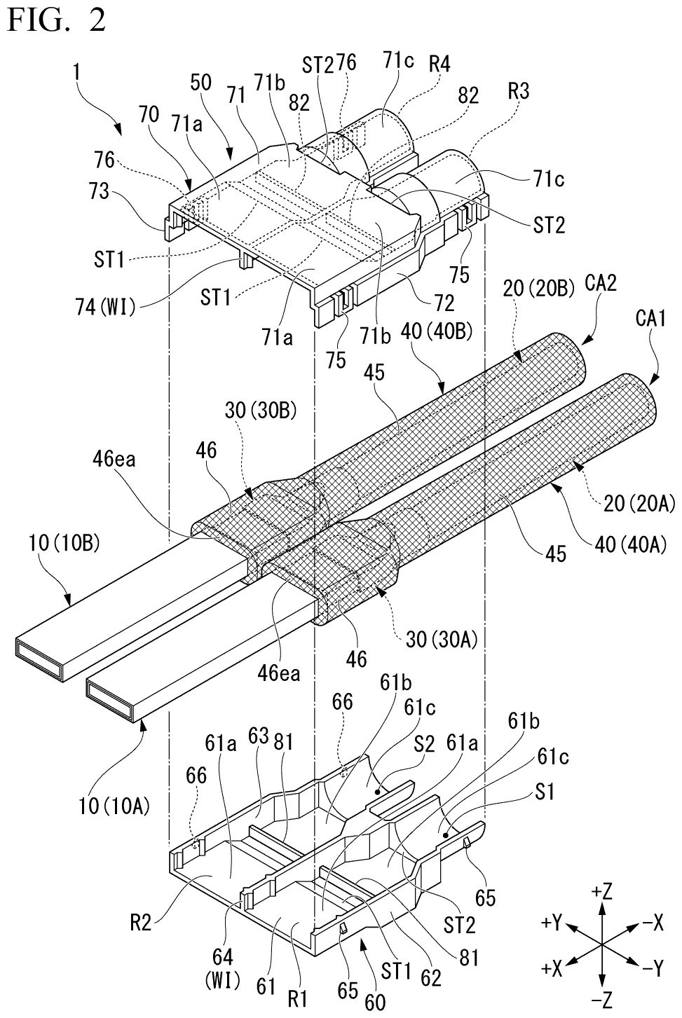

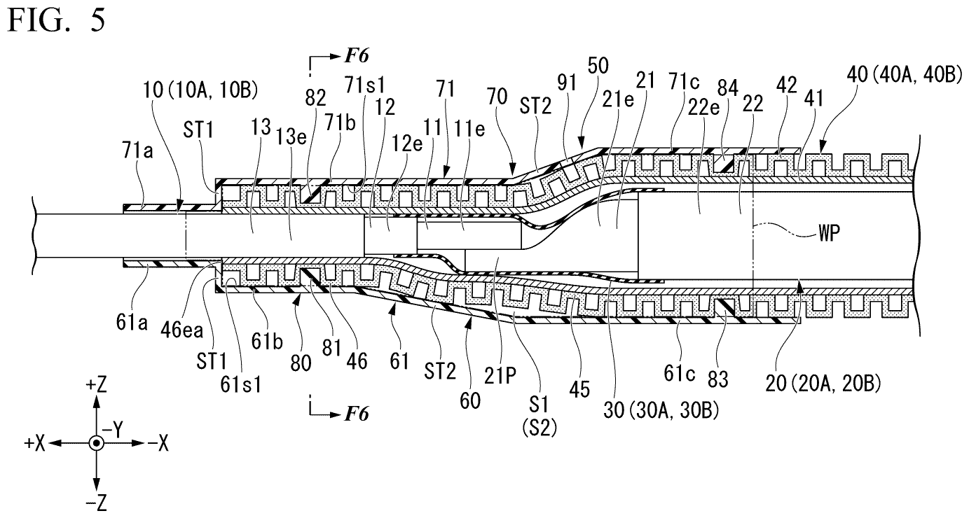

In the present disclosure, a +X direction, a −X direction, a +Y direction, a −Y direction, a +Z direction, and a −Z direction are defined as follows. The +X direction is a direction in which an end portion 21e protrudes from an insulation film 22 of an electric wire 20, as will be described later (see FIG. 5). The −X direction is a direction opposite to the +X direction. In a case where the +X direction and the −X direction are not distinguished from each other, they will be simply referred to as an “X direction”. The +Y direction and the −Y direction are directions that intersect (for example, orthogonal to) The X direction. The +Y direction is a direction from a first shield bus bar 10A toward a second shield bus bar 10B, as will be described later (see FIG. 2). The −Y direction is a direction opposite to the +Y direction. In a case where the +Y direction and the −Y direction are not distinguished from each other, they will be simply referred to as a “Y direction”. the +Z direction is a direction that intersects (for example, orthogonal to) the X direction and the Y direction. The +Z direction is a direction from a base 60 toward a cover 70, as will be described later (see FIG. 2). The −Z direction is a direction opposite to the +Z direction. In a case where the +Z direction and the −Z direction are not distinguished from each other, they will be simply referred to as a “Z direction”. The X direction is an example of a “first direction”. The Z direction is an example of a “second direction”. The Y direction is an example of a “third direction”.

### Embodiments

### <1. Overall Constitution of Routing Unit>

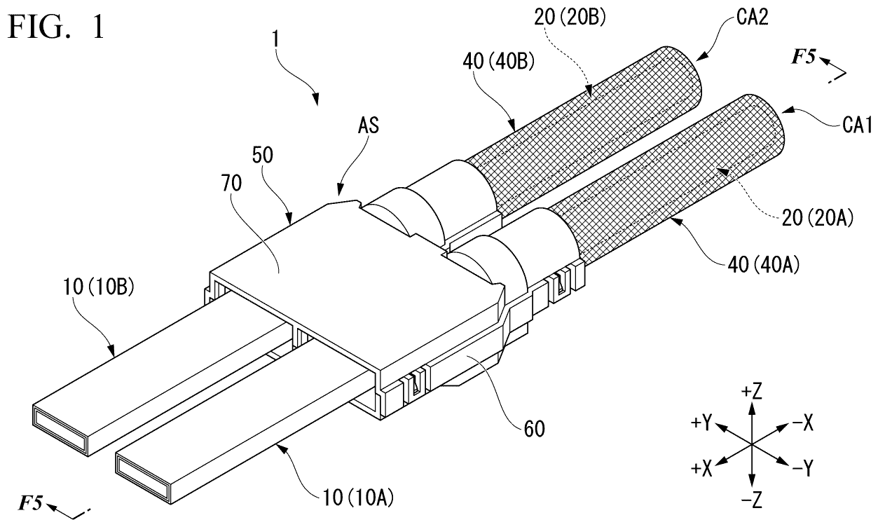

FIG. 1 is a perspective view illustrating a routing unit 1 in an embodiment. The routing unit 1 is a component for electrically connecting a plurality of components (for example, a plurality of in-vehicle components). The routing unit 1 includes, for example, a plurality of shield bus bars 10, a plurality of electric wires 20, a plurality of insulation members 30 (see FIG. 2), a plurality of shield members 40, and a connection component 50. In the present embodiment, an example of a “connection component set AS” is made up of the plurality of shield members 40 and the connection component 50.

### <2. Shield Bus Bar>

First, the shield bus bar 10 will be described.

The shield bus bar 10 is a bus bar having a shield structure. Note that in the present disclosure, the term “shield bus bar” is used for convenience of description and does not limit the scope of the invention to a specific structure.

FIG. 2 is an exploded perspective view illustrating part of the routing unit 1. In the present embodiment, the plurality of shield bus bars 10 include a first shield bus bar 10A and a second shield bus bar 10B. The first shield bus bar 10A is an example of a “first bus bar” and a “first routing member”. The second shield bus bar 10B is an example of a “second bus bar” and a “third routing member”. Hereinafter, in a case where the first shield bus bar 10A and the second shield bus bar 10B are not distinguished from each other, they will be simply referred to as the “shield bus bar 10”.

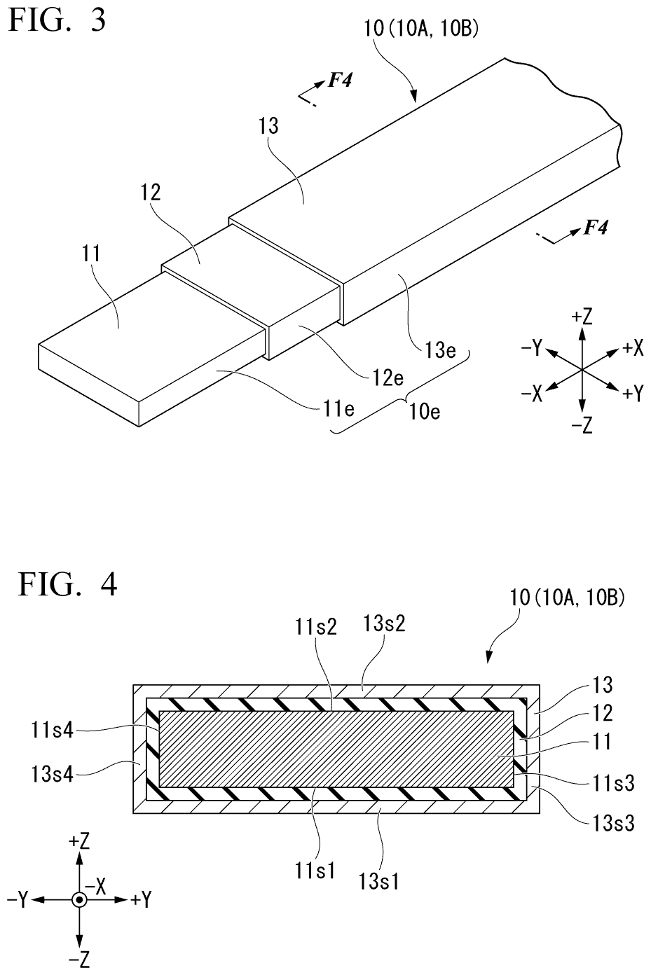

FIG. 3 is a perspective view illustrating an end portion 10e of the shield bus bar 10. FIG. 4 is a cross-sectional view taken along line F4-F4 of the shield bus bar 10 illustrated in FIG. 3. The shield bus bar 10 includes, for example, a conductor 11, an insulation film 12, and a shield layer 13.

### <2.1 Conductor>

The conductor 11 forms a conduction passage through which electric current or signals flow in the shield bus bar 10. The conductor 11 is made of metal, for example. The conductor 11 is, for example, a prismatic member having a flat rectangular cross-sectional shape.

As illustrated in FIG. 4, the conductor 11 includes a first main surface 11s1, a second main surface 11s2, a first side surface 11s3, and a second side surface 11s4. The first main surface 11s1 is positioned on an end portion of the conductor 11 on the −Z direction side. The first main surface 11s1 is a plane along The X direction and the Y direction. The second main surface 11s2 is positioned on an end portion of the conductor 11 on the +Z direction side. The second main surface 11s2 is a plane along the X direction and the Y direction. The first side surface 11s3 is positioned on an end portion of the conductor 11 on the +Y direction side. The first side surface 11s3 is a plane along the X direction and the Z direction. The second side surface 11s4 is positioned on an end portion of the conductor 11 on the −Y direction side. The second side surface 11s4 is a plane along the X direction and the Z direction. In the present embodiment, the first main surface 11s1 and the second main surface 11s2 are larger than the first side surface 11s3 and the second side surface 11s4.

As illustrated in FIG. 3, the conductor 11 includes an end portion 11e as an end portion on the −X direction side. The end portion 11e protrudes in the −X direction from an end portion 12e of the insulation film 12, as will be described later. The end portion 11e is not covered with the insulation film 12 or the shield layer 13 and is exposed to the outside of the shield bus bar 10. The end portion 11e is an example of a “conductor end portion”.

### <2.2 Insulation Film>

The insulation film 12 is an insulation member that covers the outer periphery of the conductor 11. The insulation film 12 is made of, for example, a synthetic resin. For example, the insulation film 12 covers the outer periphery of the conductor 11 to surround the entire periphery of the cross-sectional shape of the conductor 11 having a flat rectangular cross-sectional shape. The insulation film 12 includes the end portion 12e as an end portion on the −X direction side. The end portion 12e of the insulation film 12 is not covered with the shield layer 13 and is exposed to the outside of the shield bus bar 10.

### <2.3 Shield Layer>

The shield layer 13 is a shield portion that covers the outer periphery of the insulation film 12. The shield layer 13 is, for example, a shield portion for noise reduction. The shield layer 13 has braid or a mesh structure, a metal foil, or the like, but is not limited to them. In the present embodiment, the shield layer 13 is integrated with the conductor 11 and the insulation film 12. For example, the shield layer 13 covers the outer periphery of the insulation film 12 to surround the entire periphery of the cross-sectional shape of the conductor 11 having the flat rectangular cross-sectional shape.

As illustrated in FIG. 4, the shield layer 13 includes a first main surface portion 13s1, a second main surface portion 13s2, a first side surface portion 13s3, and a second side surface portion 13s4.

The first main surface portion 13s1 is positioned on an end portion of the shield layer 13 on the −Z direction side. The first main surface portion 13s1 is a flat portion along the X direction and the Y direction. The first main surface portion 13s1 is a flat portion along the first main surface 11s1 of the conductor 11.

The second main surface portion 13s2 is positioned on an end portion on the +Z direction side in the shield layer 13. The second main surface portion 13s2 is a flat portion along the X direction and the Y direction. The second main surface portion 13s2 is a flat portion along the second main surface 11s2 of the conductor 11.

The first side surface portion 13s3 is positioned on an end portion of the shield layer 13 on the +Y direction side. The first side surface portion 13s3 is a flat portion along the X direction and the Z direction. The first side surface portion 13s3 is a flat portion along the first side surface 11s3 of the conductor 11.

The second side surface portion 13s4 is positioned on an end portion of the shield layer 13 on the −Y direction side. The second side surface portion 13s4 is a flat portion along the X direction and the Z direction. The second side surface portion 13s4 is a flat portion along the second side surface 11s4 of the conductor 11.

Note that in the present disclosure, the “flat portion” is not limited to a flat portion in a strict sense and can include part that can be regarded as flat in a macroscopic view. For example, even a part including a small step, dent, gap, or the like made up of braid or a mesh structure or the like can correspond to an example of the “flat portion” in the present disclosure.

The shield layer 13 includes an end portion 13e as an end portion on the −X direction side. The end portion 13e of the shield layer 13 is positioned on the +X direction side relative to the end portion 12e of the insulation film 12. The shield layer 13 is exposed to the outside of the shield bus bar 10.

### <2.4 Shape of Shield Bus Bar>

In the present embodiment, the shield bus bar 10 includes the end portion 10e as an end portion on the +X direction side. The end portion 10e of the shield bus bar 10 includes, for example, the end portion 11e of the conductor 11, the end portion 12e of the insulation film 12, and the end portion 13e of the shield layer 13. In the present embodiment, the end portion 10e of the shield bus bar 10 extends linearly in the X direction.

### <2.5 Arrangement Structure of Two Shield Bus Bars>

As illustrated in FIG. 2, the first shield bus bar 10A and the second shield bus bar 10B are disposed side by side in the Y direction. For example, the first shield bus bar 10A and the second shield bus bar 10B are disposed side by side in the Y direction such that short sides included in the flat rectangular cross-sectional shapes of the conductors 11 face each other.

In the present disclosure, “the first bus bar and the second bus bar are disposed side by side in the Y direction” is not limited to a case where the first bus bar and the second bus bar are disposed side by side in the Y direction over the entire lengths of the first bus bar and the second bus bar, and can include a case where part of the first bus bar (for example, the end portion 10e on the −X direction side) and part of the second bus bar (for example, the end portion 10e on the −X direction side) are disposed side by side in the Y direction, but another part of the first bus bar and another part of the second bus bar are not disposed side by side in the Y direction. This definition also applies to a first electric wire 20A and a second electric wire 20B, as will be described later.

### <3. Electric Wire>

Next, the electric wire 20 will be described.

As illustrated in FIG. 2, the plurality of electric wires 20 include the first electric wire 20A and the second electric wire 20B. The first electric wire 20A is an example of a “second routing member”. The second electric wire 20B is an example of a “fourth routing member”. Hereinafter, in a case where the first electric wire 20A and the second electric wire 20B are not distinguished from each other, they will be simply referred to as the “electric wire 20”. The electric wire 20 includes, for example, a core wire 21 and an insulation film 22 (see FIG. 5).

### <3.1 Core Wire>

FIG. 5 is a cross-sectional view taken along line F5-F5 of the routing unit 1 illustrated in FIG. 1. The core wire 21 forms a conduction passage through which electric current or signals flow in the electric wire 20. The core wire 21 is made of metal, for example. The core wire 21 has, for example, a columnar shape. The core wire 21 includes the end portion 21e as an end portion on the +X direction side. The end portion 21e protrudes in the +X direction from an end portion 22e of the insulation film 22, as will be described later. The end portion 21e is not covered with the insulation film 22 and is exposed to the outside of the insulation film 22. The end portion 21e is an example of a “core wire end portion”.

The end portion 21e of the core wire 21 includes, for example, a flat portion 21p, which is formed by pressing the end portion 21e. The end portion 11e of the conductor 11 of the shield bus bar 10 and the flat portion 21p of the end portion 21e of the core wire 21 overlap each other in the Z direction. Then, the end portion 11e of the conductor 11 of the shield bus bar 10 and the flat portion 21p of the end portion 21e of the core wire 21 are joined together. By joining together in this manner, the conductor 11 of the shield bus bar 10 and the core wire 21 of the electric wire 20 are physically and electrically connected with each other. The joining method is, for example, ultrasonic welding or resistance welding, without being limited to these examples.

### <3.2 Insulation Film>

The insulation film 22 is an insulation member that covers the outer circumference of the core wire 21. The insulation film 22 is made of, for example, a synthetic resin. The insulation film 22 covers the outer circumference of the core wire 21 to surround the entire circumference of the core wire 21, for example. The insulation film 22 includes the end portion 22e as an end portion on the +X direction side.

### <3.3 Arrangement Structure of Two Electric Wires>

As illustrated in FIG. 2, the first electric wire 20A and the second electric wire 20B are disposed side by side in the Y direction. In the present embodiment, the end portion 11e of the conductor 11 of the first shield bus bar 10A and the end portion 21e of the core wire 21 of the first electric wire 20A are joined together. In addition, the end portion 11e of the conductor 11 of the second shield bus bar 10B and the end portion 21e of the core wire 21 of the second electric wire 20B are joined together.

### <4. Insulation Member>

Next, the insulation member 30 will be described.

As illustrated in FIG. 2, the plurality of insulation members 30 include a first insulation member 30A and a second insulation member 30B. Hereinafter, in a case where the first insulation member 30A and the second insulation member 30B are not distinguished from each other, they will be simply referred to as the “insulation member 30”.

As illustrated in FIG. 5, the insulation member 30 is a member that insulates and protects the end portion 11e of the conductor 11 of the shield bus bar 10 and the end portion 21e of the core wire 21 of the electric wire 20 from the outside. The insulation member 30 is provided over the end portion 12e of the insulation film 12 of the shield bus bar 10 and the end portion 22e of the insulation film 22 of the electric wire 20 in the X direction. The insulation member 30 has, for example, a tubular shape. The insulation member 30 covers the outer periphery of the end portion 11e of the conductor 11 of the shield bus bar 10, and also covers the outer circumference of the end portion 21e of the core wire 21 of the electric wire 20. The insulation member 30 is, for example, a heat shrinkable tube containing hot melt.

In the present embodiment, the first insulation member 30A is attached to a connection portion between the first shield bus bar 10A and the first electric wire 20A. On the other hand, the second insulation member 30B is attached to a connection portion between the second shield bus bar 10B and the second electric wire 20B.

### <5. Shield Member>

Next, the shield member 40 will be described.

As illustrated in FIG. 2, the plurality of shield members 40 include a first shield member 40A and a second shield member 40B. Hereinafter, in a case where the first shield member 40A and the second shield member 40B are not distinguished from each other, they will be simply referred to as the “shield member 40”.

As illustrated in FIG. 5, the shield member 40 is an exterior member provided accompanied with the electric wire 20. The shield member 40 is, for example, an exterior member for noise reduction. The shield member 40 is, for example, a sheet-shaped corrugated tube including a shield layer 41.

The shield member 40 includes, for example, the shield layer 41 and an exterior material 42. The shield layer 41 has, for example, a sheet shape. The shield layer 41 is, for example, a nonwoven fabric plated with metal. The exterior material 42 is, for example, a mesh structure provided on an outer surface of the shield layer 41. The exterior material 42 is, for example, a member plated with metal. The shield member 40 is attached by being rolled into a tubular shape to surround the entire circumference of the electric wire 20.

In the present embodiment, the shield member 40 extends on a further the +X direction side relative to the end portion 21e of the core wire 21 of the electric wire 20 to cover the outer periphery of the end portion 10e of the shield bus bar 10 in addition to the outer circumference of the electric wire 20. The shield member 40 includes a main body portion 45, which covers the outer circumference of the electric wire 20, and an end portion 46, which covers the outer periphery of the end portion 10e of the shield bus bar (for example, the outer periphery of the end portion 13e of the shield layer 13). The main body portion 45 has an annular shape along the outer circumference of the electric wire 20 having a columnar shape. The main body portion 45 is an example of a “first portion”. The end portion 46 has a flat rectangular annular shape along the outer periphery of the end portion 10e of the shield bus bar 10 having a flat prismatic shape. The end portion 46 is an example of a “second portion”.

In the present embodiment, the first shield member 40A covers the outer circumference of the first electric wire 20A and covers the outer periphery of the end portion 10e of the first shield bus bar 10A. The second shield member 40B covers the outer circumference of the second electric wire 20B and covers the outer periphery of the end portion 10e of the second shield bus bar 10B.

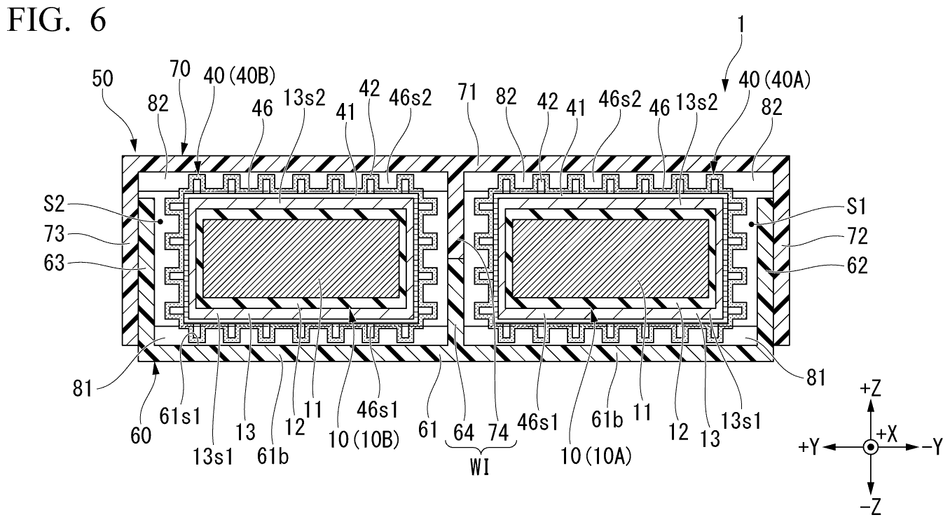

FIG. 6 is a cross-sectional view taken along line F6-F6 of the routing unit 1 illustrated in FIG. 5. The end portion 46 of the shield member 40 includes a flat portion 46s1 and a flat portion 46s2.

The flat portion 46s1 is positioned on an end portion of the shield member 40 on the −Z direction side. The flat portion 46s1 is a flat portion along the X direction and the Y direction. The flat portion 46s1 is a flat portion along the first main surface portion 13s1 of the shield layer 13 of the shield bus bar 10.

The flat portion 46s2 is positioned on an end portion of the shield member 40 on the +Z direction side. The flat portion 46s2 is a flat portion along the X direction and the Y direction. The flat portion 46s2 is a flat portion along the second main surface portion 13s2 of the shield layer 13 of the shield bus bar 10.

Note that as described above, in the present disclosure, the “flat portion” is not limited to a plane in a strict sense and can include part that can be regarded as flat in a macroscopic view. For example, even in a case where the exterior material 42 is made up of braid or a mesh structure or the like, and includes a small step, dent, gap, or the like, it can correspond to an example of the “flat portion” described in the present disclosure.

In the following, an assembly formed by assembling the first shield bus bar 10A, the first electric wire 20A, the first insulation member 30A, and the first shield member 40A will be referred to as a first conduction passage assembly CA1. In addition, an assembly formed by assembling the second shield bus bar 10B, the second electric wire 20B, the second insulation member 30B, and the second shield member 40B will be referred to as a second conduction passage assembly CA2.

### <6. Connection Component>

Next, referring back to FIG. 2, the connection component 50 will be described.

The connection component 50 is a component that presses the shield member 40 toward the shield layer 13 of the shield bus bar 10. The connection component 50 includes, for example, a base 60, a cover 70, and a pressing portion 80 (see FIG. 5).

### <6.1 Base>

The base 60 is a member that faces the first conduction passage assembly CA1 and the second conduction passage assembly CA2 from the −Z direction. The base 60 is an example of a “first member”. The base 60 is made of an insulation material such as a synthetic resin. The base 60 includes, for example, a first main wall portion 61, a first side wall portion 62, a second side wall portion 63, and an upright wall portion 64. The base 60 is open on the +Z direction side.

### (First Main Wall Portion)

The first main wall portion 61 is a wall portion that faces the first conduction passage assembly CA1 and the second conduction passage assembly CA2 from the −Z direction. The first main wall portion 61 includes a first region R1 and a second region R2. The first region R1 faces the first conduction passage assembly CA1 from the −Z direction. In the connection component 50, a first accommodation portion S1 is a space portion in which the first conduction passage assembly CA1 is disposed. The second region R2 faces the second conduction passage assembly CA2 from the −Z direction. In the connection component 50, a second accommodation portion S2 is a space portion in which the second conduction passage assembly CA2 is disposed.

In the present embodiment, the first region R1 includes, for example, a first portion 61a, a second portion 61b, and a third portion 61c.

The first portion 61a faces part of the first shield bus bar 10A from the −Z direction in a region apart from the first shield member 40A, when viewed from the Z direction. The first portion 61a is a flat wall portion along the X direction and the Y direction. The first portion 61a extends along the first main surface portion 13s1 of the shield layer 13 in the first shield bus bar 10A.

The second portion 61b is positioned on the −X direction side of the first portion 61a. The second portion 61b faces the end portion 46 of the first shield member 40A from the −Z direction. The second portion 61b is a flat wall portion along the X direction and the Y direction. The second portion 61b is along the flat portion 46s1 of the first shield member 40A.

The second portion 61b is provided to be shifted on the −Z direction side relative to the first portion 61a so that the first accommodation portion S1 is enlarged on the −Z direction side. Accordingly, a step portion ST1 in the Z direction is formed in a boundary between the first portion 61a and the second portion 61b. The step portion ST1 extends in the Y direction in a position corresponding to an end 46ea on the +X direction side of the first shield member 40A. Positioning of the first conduction passage assembly CA1 (for example, positioning of the first shield member 40A) is enabled, for example, by disposing the end 46ea on the +X direction side of the first shield member 40A along the step portion ST1.

The third portion 61c is positioned on the −X direction side of the second portion 61b. The third portion 61c faces part of the main body portion 45 of the first shield member 40A from the −Z direction. The third portion 61c has an arc shape along the outer shape of the main body portion 45 of the first shield member 40A. The third portion 61c is integrated with the first side wall portion 62 and the upright wall portion 64, as will be described later.

The third portion 61c bulges on the −Z direction side relative to the second portion 61b such that the first accommodation portion S1 is enlarged on the −Z direction side. Accordingly, a step portion ST2 in the Z direction is formed in a boundary between the second portion 61b and the third portion 61c. The step portion ST2 is provided in a position corresponding to a boundary between the main body portion 45 and the end portion 46 of the first shield member 40A. Positioning of the first conduction passage assembly CA1 (for example, positioning of the first shield member 40A) is enabled, for example, by disposing a boundary part between the main body portion 45 and the end portion 46 of the first shield member 40A along the step portion ST2.

In the present embodiment, similarly to the first region R1, the second region R2 includes the first portion 61a, the second portion 61b, and the third portion 61c. For details of the second region R2, in the above description about the first region R1, “the first shield bus bar 10A” may be replaced with “the second shield bus bar 10B”, and “the first shield member 40A” may be replaced with “the second shield member 40B”.

### (First Side Wall Portion)

The first side wall portion 62 is a wall portion that protrudes in the +Z direction from an end portion on the −Y direction side of the first main wall portion 61. The first side wall portion 62 extends along the X direction and the Z direction. The first side wall portion 62 faces part of the first shield bus bar 10A and the end portion 46 of the first shield member 40A from the −Y direction. The first side wall portion 62 includes, for example, a first engagement portion 65 to engage with a third side wall portion 72 of the cover 70, as will be described later. The first engagement portion 65 is, for example, a claw portion that protrudes in the −Y direction.

### (Second Side Wall Portion)

The second side wall portion 63 is a wall portion that protrudes in the +Z direction from an end portion on the +Y direction side of the first main wall portion 61. The second side wall portion 63 extends along the X direction and the Z direction. The second side wall portion 63 faces part of the second shield bus bar 10B and the end portion 46 of the second shield member 40B from the +Y direction. The second side wall portion 63 includes, for example, a second engagement portion 66 to engage with a fourth side wall portion 73 of the cover 70, as will be described later. The second engagement portion 66 is, for example, a claw portion that protrudes in the +Y direction.

### (Upright Wall Portion)

The upright wall portion 64 is a wall portion that protrudes in the +Z direction from a center portion in the Y direction of the first main wall portion 61. The upright wall portion 64 is positioned between the first region R1 and the second region R2 of the first main wall portion 61. The upright wall portion 64 extends along the X direction and the Z direction. The upright wall portion 64 forms part or the entirety of an insulation wall WI of the connection component 50. The insulation wall WI is a wall portion that partitions the inside of the connection component 50 into the first accommodation portion S1 and the second accommodation portion S2 so that the first conduction passage assembly CA1 and the second conduction passage assembly CA2 do not come into contact with each other.

### <6.2 Cover>

The cover 70 is a member disposed on an opposite side of the base 60 with respect to the first conduction passage assembly CA1 and the second conduction passage assembly CA2. The cover 70 faces the first conduction passage assembly CA1 and the second conduction passage assembly CA2 from the +Z direction. The cover 70 is an example of a “second member”. The cover 70 is made of an insulation material such as a synthetic resin. The cover 70 is assembled with the base 60 (for example, engages with the base 60). The cover 70 includes, for example, a second main wall portion 71, a third side wall portion 72, a fourth side wall portion 73, and an upright wall portion 74.

### (Second Main Wall Portion)

The second main wall portion 71 is a wall portion that faces the first conduction passage assembly CA1 and the second conduction passage assembly CA2 from the +Z direction. The second main wall portion 71 includes a third region R3 and a fourth region R4. The third region R3 faces the first conduction passage assembly CA1 from the +Z direction. The fourth region R4 faces the second conduction passage assembly CA2 from the +Z direction.

In the present embodiment, the third region R3 includes, for example, a first portion 71a, a second portion 71b, and a third portion 71c. For details of the first portion 71a, the second portion 71b, and the third portion 71c of the third region R3, in the above description of the first portion 61a, the second portion 61b, and the third portion 61c of the first region R1, “the −Z direction” may be replaced with “the +Z direction”, “the first main surface portion 13s1” may be replaced with “the second main surface portion 13s2”, and “the flat portion 46s1” may be replaced with “the flat portion 46s2”.

In the present embodiment, similarly to the third region R3, the fourth region R4 includes a first portion 71a, a second portion 71b, and a third portion 71c. For details of the first portion 71a, the second portion 71b, and the third portion 71c of the fourth region R4, in the above description of the first portion 61a, the second portion 61b, and the third portion 61c of the first region R1, “the −Z direction” may be replaced with “the +Z direction”, “the first shield bus bar 10A” may be replaced with “the second shield bus bar 10B”, “the first shield member 40A” may be replaced with “the second shield member 40B”, “the first main surface portion 13s1” may be replaced with “the second main surface portion 13s2”, and “the flat portion 46s1” may be replaced with “the flat portion 46s2”

### (Third Side Wall Portion)

The third side wall portion 72 is a wall portion that protrudes in the −Z direction from an end portion on the −Y direction side of the second main wall portion 71. The third side wall portion 72 extends along the X direction and the Z direction. For example, the third side wall portion 72 is adjacent to the first side wall portion 62 of the base 60 from the −Y direction side. The third side wall portion 72 includes an engagement portion 75 to engage with the first side wall portion 62. The engagement portion 75 is, for example, an engagement hole to engage with the engagement portion 65 of the base 60, which is a claw portion. When the engagement portion 75 of the cover 70 and the engagement portion 65 of the base 60 engage with each other, the base 60 and the cover 70 are assembled with each other.

### (Fourth Side Wall Portion)

The fourth side wall portion 73 is a wall portion that protrudes in the −Z direction from an end portion on the +Y direction side of the second main wall portion 71. The fourth side wall portion 73 extends along the X direction and the Z direction. For example, the fourth side wall portion 73 is adjacent to the second side wall portion 63 of the base 60 from the +Y direction side. The fourth side wall portion 73 includes an engagement portion 76 to engage with the second side wall portion 63. The engagement portion 76 is, for example, an engagement hole to engage with the engagement portion 66 of the base 60, which is a claw portion. When the engagement portion 76 of the cover 70 and the engagement portion 66 of the base 60 engage with each other, the base 60 and the cover 70 are assembled with each other.

### (Upright Wall Portion)

The upright wall portion 74 is a wall portion that protrudes in the −Z direction from a center portion of the second main wall portion 71 in the Y direction. The upright wall portion 74 is positioned between the third region R3 and the fourth region R4 of the second main wall portion 71. The upright wall portion 74 extends along the X direction and the Z direction. The upright wall portion 74 forms part or the entirety of the insulation wall WI. In the present embodiment, the insulation wall WI is formed by assembling the upright wall portion 74 of the cover 70 with the upright wall portion 64 of the base 60. Note that instead of the above example, the insulation wall WI may be made up of only the upright wall portion 64 of the base 60 or may be made up of only the upright wall portion 74 of the cover 70.

### <6.3 Pressing Portion>

The pressing portion 80 is a part that presses the end portion 46 of the shield member 40 toward the end portion 13e of the shield layer 13 of the shield bus bar 10, when the base 60 and the cover 70 are assembled with each other. The pressing portion 80 is provided on at least one of the base 60 or the cover 70.

As illustrated in FIG. 5, in the present embodiment, the pressing portion 80 includes, for example, a first protrusion portion 81, a second protrusion portion 82, a third protrusion portion 83, and a fourth protrusion portion 84.

### (First Protrusion Portion)

The first protrusion portion 81 is provided on the second portion 61b of the first main wall portion 61 of the base 60. The first protrusion portion 81 is provided at a position that overlaps the end portion 46 of the shield member 40 (a position that overlaps the end portion 13e of the shield layer 13 of the shield bus bar 10), when viewed from the Z direction. The first protrusion portion 81 protrudes in the +Z direction from an inner surface 61s1 of the second portion 61b of the first main wall portion 61. When the base 60 and the cover 70 are assembled with each other (for example, engage with each other), the first protrusion portion 81 comes into contact with the end portion 46 of the shield member 40 from the −Z direction side, and presses the end portion 46 of the shield member 40 toward the end portion 13e of the shield layer 13 of the shield bus bar 10. When the end portion 46 of the shield member 40 is pressed toward the end portion 13e of the shield layer 13 of the shield bus bar 10, the end portion 46 of the shield member 40 and the end portion 13e of the shield layer 13 come into contact with each other with certainty. The end portion 46 of the shield member 40 and the end portion 13e of the shield layer 13 is in contact with each other with certainty, and thus electric connection between the end portion 46 of the shield member 40 and the end portion 13e of the shield layer 13 is stabilized.

As illustrated in FIG. 6, the first protrusion portion 81 is a rib that extends in the Y direction to have a constant height with respect to the inner surface 61s1 of the first main wall portion 61. When viewed from the Z direction, the first protrusion portion 81 overlaps the flat portion 46s1 of the end portion 46 of the shield member 40 and the first main surface portion 13s1 of the shield layer 13 of the shield bus bar 10. When the base 60 and the cover 70 are assembled with each other (for example, engage with each other), the first protrusion portion 81 presses the flat portion 46s1 of the end portion 46 of the shield member 40 toward the first main surface portion 13s1 of the shield layer 13 of the shield bus bar 10.

In the present embodiment, the first protrusion portion 81 is provided in each the first region R1 and the second region R2, on the first main wall portion 61 of the base 60. The first protrusion portion 81, which is provided in the first region R1, presses the flat portion 46s1 of the end portion 46 of the first shield member 40A toward the first main surface portion 13s1 of the shield layer 13 of the first shield bus bar 10A. On the other hand, the first protrusion portion 81, which is provided in the second region R2, presses the flat portion 46s1 of the end portion 46 of the second shield member 40B toward the first main surface portion 13s1 of the shield layer 13 of the second shield bus bar 10B.

### (Second Protrusion Portion)

As illustrated in FIG. 5, the second protrusion portion 82 is provided on the second portion 71b of the second main wall portion 71 of the cover 70. The second protrusion portion 82 is provided in a position that overlaps the end portion 46 of the shield member 40, when viewed from the Z direction (a position that overlaps the end portion 13e of the shield layer 13 of the shield bus bar 10). For example, the second protrusion portion 82 is disposed in a position that faces the first protrusion portion 81 in the Z direction. The second protrusion portion 82 protrudes in the −Z direction from an inner surface 71s1 of the second portion 71b of the second main wall portion 71. When the base 60 and the cover 70 are assembled with each other (for example, engage with each other), the second protrusion portion 82 comes into contact with the end portion 46 of the shield member 40 from the +Z direction side, and presses the end portion 46 of the shield member 40 toward the end portion 13e of the shield layer 13 of the shield bus bar 10. When the end portion 46 of the shield member 40 is pressed toward the end portion 13e of the shield layer 13 of the shield bus bar 10, the end portion 46 of the shield member 40 and the end portion 13e of the shield layer 13 come into contact with each other with certainty. As described above, the end portion 46 of the shield member 40 and the end portion 13e of the shield layer 13 is in contact with each other with certainty, and thus the electric connection between the end portion 46 of the shield member 40 and the end portion 13e of the shield layer 13 is stabilized. In the present embodiment, the end portion 46 of the shield member 40 is sandwiched from both sides in the Z direction by the first protrusion portion 81 and the second protrusion portion 82.

As illustrated in FIG. 6, the second protrusion portion 82 is a rib that extends in the Y direction to have a constant height with respect to the inner surface 71s1 of the second main wall portion 71. When viewed from the Z direction, the second protrusion portion 82 overlaps the flat portion 46s2 of the end portion 46 of the shield member 40 and the second main surface portion 13s2 of the shield layer 13 of the shield bus bar 10. When the base 60 and the cover 70 are assembled with each other (for example, engage with each other), the second protrusion portion 82 presses the flat portion 46s2 of the end portion 46 of the shield member 40 toward the second main surface portion 13s2 of the shield layer 13 of the shield bus bar 10.

In the present embodiment, the second protrusion portion 82 is provided in each the third region R3 and the fourth region R4 in the second main wall portion 71 of the cover 70. The second protrusion portion 82, which is provided in the third region R3, presses the flat portion 46s2 of the end portion 46 of the first shield member 40A toward the second main surface portion 13s2 of the shield layer 13 of the first shield bus bar 10A. On the other hand, the second protrusion portion 82, which is provided in the fourth region R4, presses the flat portion 46s2 of the end portion 46 of the second shield member 40B toward the second main surface portion 13s2 of the shield layer 13 of the second shield bus bar 10B.

### (Third Protrusion Portion)

The third protrusion portion 83 is provided on the first main wall portion 61 of the base 60. The third protrusion portion 83 is provided in a position that overlaps the main body portion 45 of the shield member 40, when viewed from the Z direction. The third protrusion portion 83 protrudes in the +Z direction from the inner surface 61s1 of the first main wall portion 61 of the base 60. When the base 60 and the cover 70 are assembled with each other (for example, engage with each other), the third protrusion portion 83 comes into contact with the main body portion 45 of the shield member 40 from the −Z direction side. The third protrusion portion 83 is in contact with the main body portion 45 of the shield member 40, and thus the main body portion 45 of the shield member 40 is stably held.

### (Fourth Protrusion Portion)

The fourth protrusion portion 84 is provided on the second main wall portion 71 of the cover 70. The fourth protrusion portion 84 is provided in a position that overlaps the main body portion 45 of the shield member 40, when viewed from the Z direction. The fourth protrusion portion 84 protrudes in the −Z direction from the inner surface 71s1 of the second main wall portion 71 of the cover 70. When the base 60 and the cover 70 are assembled with each other (for example, engage with each other), the fourth protrusion portion 84 comes into contact with the main body portion 45 of the shield member 40 from the +Z direction side. The fourth protrusion portion 84 is in contact with the main body portion 45 of the shield member 40, and thus the main body portion of the shield member 40 is stably held.

### <7.Additional Waterproof Treatment>

The connection component 50 may include a waterproof portion WP (see FIG. 5) in addition to the above-described constitution. The waterproof portion WP is a part on which waterproof treatment for suppressing corrosion of a connection part between the conductor 11 of the shield bus bar 10 and the core wire 21 of the electric wire 20 has been performed. The waterproof portion WP is formed between the base 60 and the cover 70 with a potting material injected between the base 60 and the cover 70. For example, the waterproof portion WP is formed with the potting material injected between the base 60 and the cover 70 through an injection hole 91, which is provided in the base 60 or the cover 70.

### <8. Method for Assembling Routing Unit 1>

Next, a method for assembling the routing unit 1 will be described.

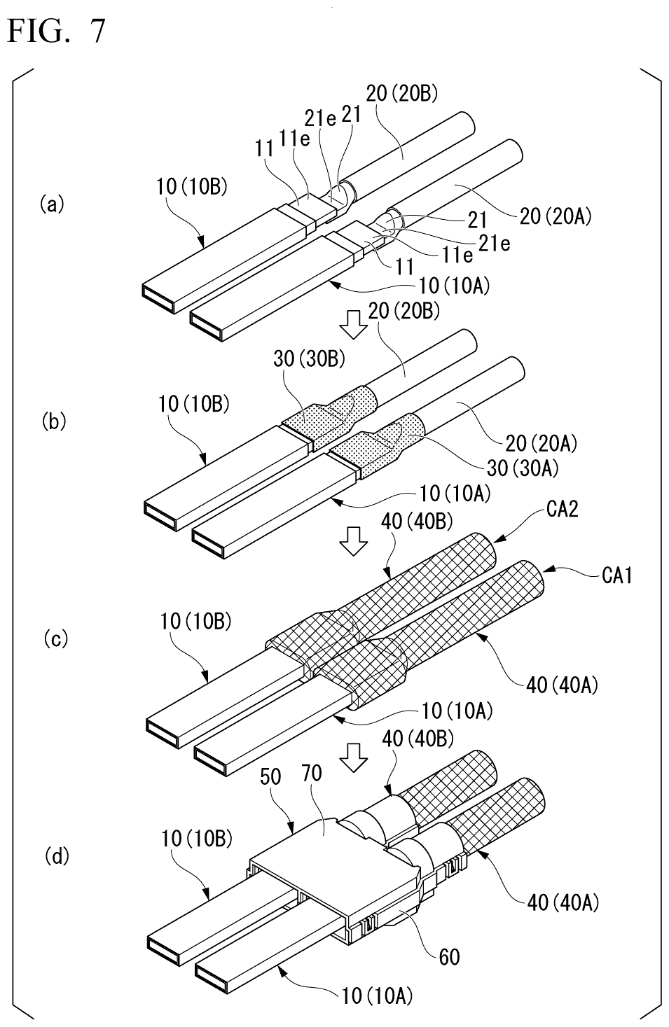

FIG. 7 is a diagram for describing the method for assembling the routing unit 1. First, the end portion 11e of the conductor 11 of the first shield bus bar 10A and the end portion 21e of the core wire 21 of the first electric wire 20A are joined together. In addition, the end portion 11e of the conductor 11 of the second shield bus bar 10B and the end portion 21e of the core wire 21 of the second electric wire 20B are joined together (see (a) of FIG. 7).

Next, the insulation member 30 is attached. For example, the first insulation member 30A before thermal shrinkage is attached to the connection portion between the first shield bus bar 10A and the first electric wire 20A. In addition, the second insulation member 30B before thermal shrinkage is attached to the connection portion between the second shield bus bar 10B and the second electric wire 20B. Then, thermal treatment is performed to thermally shrink the first insulation member 30A and the second insulation member 30B (see (b) of FIG. 7). By this processing, insulation properties of the connection portion between the first shield bus bar 10A and the first electric wire 20A and the connection portion between the second shield bus bar 10B and the second electric wire 20B are ensured.

Next, the shield member 40 is attached. For example, the first shield member 40A is provided to cover the outer periphery of the end portion 10e of the first shield bus bar 10A and the outer circumference of the first electric wire 20A. In addition, the second shield member 40B is attached to cover the outer periphery of the end portion 10e of the second shield bus bar 10B and the outer circumference of the second electric wire 20B (see (c) in FIG. 7). Thus, the first conduction passage assembly CA1 and the second conduction passage assembly CA2 are assembled.

Next, the connection component 50 is attached. For example, the first conduction passage assembly CA1 and the second conduction passage assembly CA2 are placed inside the base 60, in a state in which the base 60 and the cover 70 are separated from each other. Next, the cover 70 is assembled with the base 60 (see (d) in FIG. 7). When the cover 70 is assembled with the base 60, the first protrusion portion 81 and the second protrusion portion 82 each press the end portion 46 of the first shield member 40A toward the end portion 13e of the shield layer 13 of the first shield bus bar 10A, and also press the end portion 46 of the second shield member 40B toward the end portion 13e of the shield layer 13 of the second shield bus bar 10B.

### <9.Advantages>

In a case of assuming a constitution in which a bus bar including a shield layer is connected with an electric wire provided with a shield member, the work of electrically connecting the above shield layer and the above shield member may be complicated.

On the other hand, in the present embodiment, the shield member 40 is provided. The shield member 40 includes the main body portion 45, which covers the outer circumference of the insulation film 22 of the electric wire 20, and the end portion 46, which covers the outer periphery of the end portion 13e of the shield layer 13 of the shield bus bar 10. The connection component 50 includes the base 60, the cover 70, and the pressing portion 80. The base 60 faces the shield member 40 from the Z direction. The cover 70 is disposed on an opposite side of the base 60 with respect to the shield member 40, and is assembled with the base 60. When the base 60 and the cover 70 are assembled with each other, the pressing portion 80 presses the end portion 46 of the shield member 40 toward the end portion 13e of the shield layer 13. According to such a constitution, the end portion 46 of the shield member 40 is pressed toward the end portion 13e of the shield layer 13 by the pressing portion 80, so that the work of electrically connecting the shield member 40 with the shield layer 13 can be facilitated. Therefore, work performance can be improved.

In the present embodiment, the shield member 40 is a corrugated tube having a sheet shape and includes the shield layer 41. According to such a constitution, it becomes possible to easily connect the shield member 40, which is a corrugated tube having a sheet shape, with the shield layer 13 of the shield bus bar 10.

In the present embodiment, the pressing portion 80 is provided on the base 60 or the cover 70, and includes the protrusion portion 81 or the protrusion portion 82, which presses the end portion 46 of the shield member 40 toward the end portion 13e of the shield layer 13. According to such a constitution, the end portion 46 of the shield member 40 can be pressed with more certainty toward the end portion 13e of the shield layer 13 by the protrusion portion 81 or the protrusion portion 82.

In the present embodiment, the shield member 40 includes the flat portion 46s1 or the flat portion 46s2 along the main surface portion 13s1 or the second main surface portion 13s2 of the shield layer 13. The protrusion portion 81 or the protrusion portion 82 is a rib that extends in the Y direction. The protrusion portion 81 or the protrusion portion 82 presses the flat portion 46s1 or the flat portion 46s2 of the shield member 40 toward the first main surface portion 13s1 or the second main surface portion 13s2 of the shield layer 13. According to such a constitution, it becomes possible to increase the contact area between the shield member 40 and the shield layer 13 by using the structure including the flat portion 46s1 or the flat portion 46s2.

In the present embodiment, at least one of the base 60 or the cover 70 includes the step portion ST1, which is provided in a position corresponding to the end 46ea of the shield member 40 in the X direction, and which limits the position of the shield member in the X direction. According to such a constitution, the base 60 or the cover 70 enables positioning of the shield member 40 in the X direction and/or suppression of positional deviation.

In the present embodiment, when the base 60 and the cover 70 are assembled with each other, the pressing portion 80 presses the end portion 46 of the first shield member 40A toward the end portion 13e of the shield layer 13 of the first shield bus bar 10A, and also presses the end portion 46 of the second shield member 40B toward the end portion 13e of the shield layer 13 of the second shield bus bar 10B. According to such a constitution, it becomes possible to collectively do the work of assembling the base 60 and the cover 70 with each other and the work of electrically connecting the plurality of pairs of shield members 40 with the shield layer 13.

### <10. Modifications>

Next, modifications of the embodiments will be described. Note that any constitution other than constitutions to be described below is the same as the constitution in the above-described embodiments.

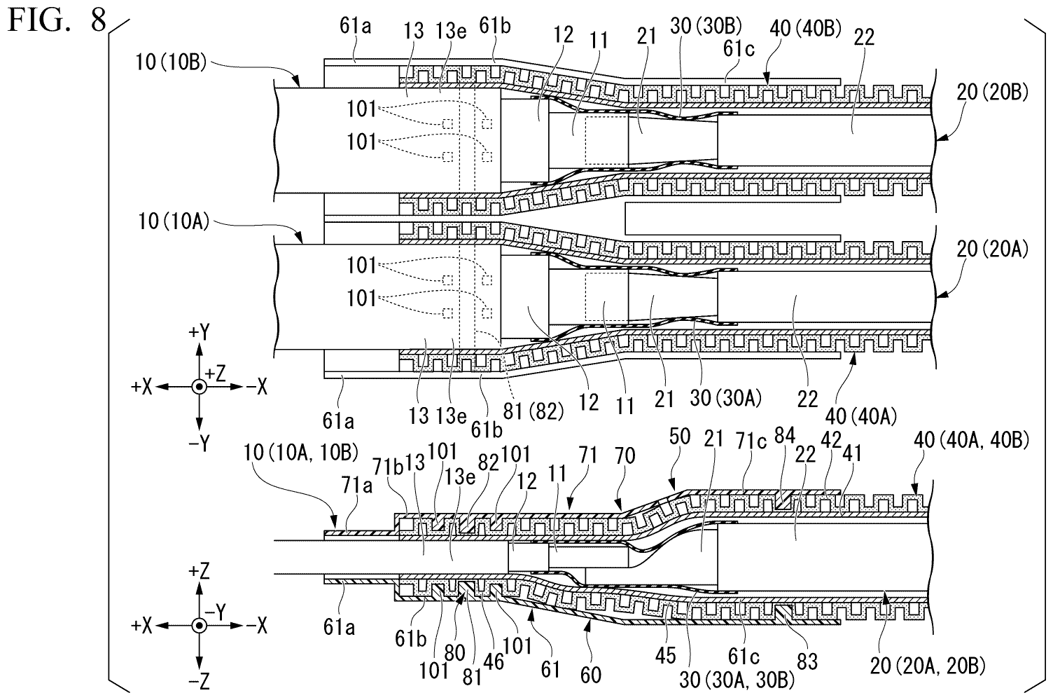

FIG. 8 is a diagram illustrating a cross-section of the routing unit 1 in a modification. In the present modification, the shield member 40 has braid or a mesh structure, and includes a plurality of dents or gaps. For example, the exterior material 42 of the shield member 40 has braid or a mesh structure and includes a plurality of dents or gaps.

In the present modification, at least one of the base 60 or the cover 70 includes a plurality of projections 101. The plurality of projections 101 project from the first main wall portion 61 or the second main wall portion 71 toward the end portion 46 of the shield member 40. The plurality of projections 101 are disposed at equal intervals in the X direction and the Y direction, for example. The plurality of projections 101 mesh with the end portion 46 of the shield member 40 from the Z direction.

In the present modification, the plurality of projections 101 are provided on the second portion 61b of the first main wall portion 61 of the base 60 or the second portion 71b of the second main wall portion 71 of the cover 70. The plurality of projections 101 include two or more projections 101, which are disposed in different positions with respect to the Y direction. In the present disclosure, “disposed in different positions with respect to the Y direction” is not limited to the case of being disposed side by side in the Y direction, and can include a case of being disposed in positions obliquely shifted from each other with respect to the Y direction. The above two or more projections 101 mesh with the flat portion 46s1 or the flat portion 46s2 of the end portion 46 of the shield member 40 from the Z direction.

As described above, in the present modification, the connection component 50 includes the plurality of projections 101, which mesh with the end portion 46 of the shield member 40. According to such a constitution, the plurality of projections 101 enable the positioning of the first conduction passage assembly CA1 and the second conduction passage assembly CA2 and/or suppression of positional deviation.

In the present modification, two or more projections 101, which are disposed in different positions with respect to the Y direction, mesh with the flat portion 46s1 or the flat portion 46s2 of the end portion 46 of the shield member 40. According to such a constitution, the positioning of the first conduction passage assembly CA1 and the second conduction passage assembly CA2 and/or the suppression of the positional deviation are/is enabled more firmly, by using the constitution of the shield member 40, which includes the flat portion 46s1 or the flat portion 46s2.

Here, in attempting to provide two or more projections as described above on the base or the cover corresponding to the shield cable having a columnar shape, all the projections are to be provided to face the center of the conductor. In this case, an undercut problem occurs in the molding of the base or the cover, and it is difficult to provide the projections as described above. On the other hand, in the present embodiment, the projections 101 are provided by using the structure of the base 60 or the cover 70 for the shield bus bar 10, thereby facilitating forming of the projections 101.

Note that the plurality of projections 101 may mesh with the main body portion of the shield member 40, instead of the end portion 46 of the shield member 40. In addition, the plurality of projections 101 may mesh with the shield layer 13 of the shield bus bar 10, instead of or in addition to the shield member 40. Also, in a constitution in which the plurality of projections 101 mesh with the shield layer 13, the positioning of the first conduction passage assembly CA1 and the second conduction passage assembly CA2 and/or suppression of positional deviation are/is enabled.

Heretofore, embodiments and a plurality of modifications have been described. However, the embodiments and the modifications are not limited to the examples described above. For example, a plurality of modifications may be achieved in combination with each other. For example, in the above-described embodiment, the engagement portions 65 and 66 of the base 60 are claw portions, and the engagement portions 75 and 76 of the cover 70 are engagement holes. Alternatively, the engagement portions 75 and 76 of the cover 70 may be claw portions, and the engagement portions 65 and 66 of the base 60 may be engagement holes.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

### INDUSTRIAL APPLICABILITY

According to the present disclosure, it becomes possible to provide a connection component and a connection component set that are capable of improving work performance.

### Brief Description of the Reference Symbols

1 Routing unit
10 Shield bus bar
10A First shield bus bar (first bus bar, first routing member)
10B Second shield bus bar (second bus bar, third routing member)
11 Conductor
12 Insulation film
13 Shield layer
20 Electric wire
20A First electric wire (second routing member)
20B Second electric wire (fourth routing member)
21 Core wire
22 Insulation film
30 Insulation member
30A First insulation member
30B Second insulation member
40 Shield member
40A First shield member
40B Second shield member
50 Connection component
60 Base (first member)
70 Cover (second member)
80 Pressing portion
81 First protrusion portion
82 Second protrusion portion
101 Projection
ST1 Step portion
AS Connection component set

What is claimed is:

1. A connection component used for a routing unit including a first routing member and a second routing member, wherein
the first routing member is a first bus bar including a conductor, an insulation film that covers an outer periphery of the conductor, and a shield layer that covers an outer periphery of the insulation film, and the conductor includes a conductor end portion that protrudes from the shield layer,
the second routing member is a first electric wire including a core wire and an insulation film that covers an outer circumference of the core wire, and the core wire includes a core wire end portion that protrudes from the insulation film of the first electric wire,
the connection component comprising:
a first member, a second member, and a pressing portion,
in a case where a first direction is defined as a direction in which the core wire end portion protrudes from the insulation film of the first electric wire, the first member faces the first shield member from a second direction that intersects a first direction, in a state in which the conductor end portion and the core wire end portion are joined together and a first shield member is provided, the first shield member including a first portion that covers an outer circumference of the first electric wire, and a second portion that covers an outer periphery of an end portion of the shield layer,
the second member is disposed on an opposite side of the first member with respect to the first shield member, and is assembled with the first member, and
the pressing portion is provided on at least one of the first member or the second member, and presses the second portion of the first shield member toward the end portion of the shield layer, when the first member and the second member are assembled with each other.

2. The connection component according to claim 1, wherein
the first shield member is a corrugated tube having a sheet shape and includes a shield layer.

3. The connection component according to claim 1, wherein
the pressing portion includes a protrusion portion that is provided either on the first member or the second member and presses the second portion of the first shield member toward the end portion of the shield layer.

4. The connection component according to claim 3, wherein
the shield layer includes a flat portion along a third direction that intersects the first direction and the second direction,
the first shield member includes a flat portion along the flat portion of the shield layer, and
the protrusion portion is a rib that extends in the third direction and presses the flat portion of the first shield member toward the flat portion of the shield layer.

5. The connection component according to claim 1, wherein
at least one of the first member or the second member includes a step portion provided in a position corresponding to an end in the first direction of the first shield member to limit a position in the first direction of the first shield member.

6. The connection component according to claim 1, wherein
at least one of the first member and the second member includes a plurality of projections that mesh with either the first shield member or the shield layer.

7. The connection component according to claim 1, wherein
the routing unit further includes a third routing member and a fourth routing member,
the third routing member is a second bus bar including a conductor, an insulation film that covers an outer periphery of the conductor, and a shield layer that covers an outer periphery of the insulation film, and the conductor of the third routing member includes a conductor end portion that protrudes from the shield layer of the third routing member,
the second routing member is a second electric wire including a core wire and an insulation film that covers an outer circumference of the core wire, and the core wire of the second electric wire includes a core wire end portion that protrudes from the insulation film of the second electric wire,
the first member faces the second shield member from the second direction, in a state in which the conductor end portion of the second bus bar and the core wire end portion of the second electric wire are joined together and a second shield member is provided, the second shield member including a first portion that covers an outer circumference of an insulation film of the second electric wire and a second portion that covers an outer periphery of an end portion of the shield layer of the second bus bar,
the second member is disposed on an opposite side of the first member with respect to the second shield member, and
the pressing portion presses the second portion of the first shield member toward the end portion of the shield layer of the first bus bar, and also presses the second portion of the second shield member toward the end portion of the shield layer of the second bus bar, when the first member and the second member are assembled with each other.

8. A connection component set used for a routing unit including a first routing member and a second routing member, wherein
the first routing member is a bus bar including a conductor, an insulation film that covers an outer periphery of the conductor, and a shield layer that covers an outer periphery of the insulation film, and the conductor includes a conductor end portion that protrudes from the shield layer,
the second routing member is an electric wire including a core wire and an insulation film that covers an outer circumference of the core wire, and the core wire includes a core wire end portion that protrudes from the insulation film of the electric wire,
the connection component set comprising a shield member and a connection component,
the shield member including a first portion that covers an outer circumference of the insulation film of the electric wire, and a second portion that covers an outer periphery of an end portion of the shield layer,
the connection component including a first member, a second member, and a pressing portion,
in a case where a first direction is defined as a direction in which the core wire end portion protrudes from the insulation film of the electric wire, the first member faces the shield member from a second direction that intersects the first direction, in a state in which the conductor end portion and the core wire end portion are joined together and the shield member is provided to cover an outer circumference of the insulation film of the electric wire and an outer periphery of the end portion of the shield layer,
the second member is disposed on an opposite side of the first member with respect to the shield member, and is assembled with the first member, and
the pressing portion is provided on at least one of the first member or the second member, and presses the second portion of the shield member toward the end portion of the shield layer, when the first member and the second member are assembled with each other.
